(19) United States
(12) Patent Application Publication
(10) Pub. No.: US 2024/0178370 A1
(43) Pub. Date: May 30, 2024

(54) Cathode Plate and Preparation Method Therefor, and Lithium Ion Battery

(71) Applicant: JIANGSU ZENERGY BATTERY TECHNOLOGIES CO., LTD., Jiangsu (CN)

(72) Inventors: Huiwen ZHAO, Jiangsu (CN); Yeqiong ZHANG, Jiangsu (CN); Silin LI, Jiangsu (CN); Haixu HUANG, Jiangsu (CN); Kecheng JIANG, Jiangsu (CN)

(21) Appl. No.: 18/512,581

(22) Filed: Nov. 17, 2023

(30) Foreign Application Priority Data
Nov. 29, 2022 (CN) 202211503523.9

(51) Int. Cl. H01M 4/36; H01M 4/04; H01M 4/131; H01M 4/136; H01M 4/1391; H01M 4/1397; H01M 4/505; H01M 4/525; H01M 4/58; H01M 4/587; H01M 10/0525

(52) U.S. Cl. CPC H01M 4/364; H01M 4/0404; H01M 4/131; H01M 4/136; H01M 4/1391; H01M 4/1397; H01M 4/366; H01M 4/505; H01M 4/525; H01M 4/5825; H01M 4/587; H01M 10/0525; H01M 2004/028

(57) ABSTRACT

Disclosed are a cathode plate and a preparation method therefor, and a lithium ion battery, which relate to the technical field of batteries. The cathode plate includes: a cathode current collector and a cathode film provided on the cathode current collector, wherein a cathode active material of the cathode film comprises a first active material, a second active material and a third active material, the first active material is a medium-nickel low-cobalt or cobalt-free transition metal oxide, the second active material is a high-nickel transition metal oxide, and the third active material is a lithium-containing phosphate having an olivine structure. A medium-nickel material and a high-nickel material are compounded, which can improve the energy density, low-temperature dynamic performance and cycle performance of the material; the phosphate material and the layered transition metal material have different discharge plateaus, which can improve the low-temperature power performance of the material.

### TECHNICAL FIELD

The present disclosure relates to the technical field of batteries, and in particular, to a cathode plate and a preparation method therefor, and a lithium ion battery.

### BACKGROUND

A lithium ion battery is the most widely applied portable electrochemical energy storage devices at present, and is also considered to be the most preferred choice for power systems of new energy vehicles. Improving the energy density, power performance and cycle life of a power lithium ion battery, reducing costs and improving the safety performance thereof have always been the focus of product development; in a lithium ion battery, the properties above are all directly affected and determined by a cathode. Therefore, the performance of the lithium ion battery in various aspects can often be significantly improved by adjusting and modifying the cathode.

In the related art, the energy density of the battery can be effectively improved by reasonably proportioning a medium-nickel transition metal oxide material and a high-nickel transition metal oxide material and then taking same as a cathode active material. However, the high-nickel transition metal oxide has poor thermal stability, so that the safety performance of the battery is reduced, and the energy density and safety performance of the battery cannot be satisfied at the same time.

In view of this, the present disclosure is specifically proposed.

### SUMMARY

An object of the present disclosure is to provide a cathode plate and a preparation method therefor, and a lithium ion battery, which can simultaneously ensure the energy density, low-temperature power performance and safety performance of the lithium ion battery.

Embodiments of the present disclosure are implemented as follows:

According to a first aspect, some embodiments of the present disclosure provide a cathode plate, comprising:
a cathode current collector and a cathode film provided on at least one surface of the cathode current collector, wherein a cathode active material of the cathode film comprises a first active material, a second active material and a third active material, the first active material is a medium-nickel low-cobalt or cobalt-free transition metal oxide, the second active material is a high-nickel transition metal oxide, and the third active material is a lithium-containing phosphate having an olivine structure.

In optional embodiments, the first active material has a chemical formula of Liₐ₁(Niₓ₁Co_{y1}Mn_{z1}G_{b1})O_{2-c1}D_{c1}; wherein 0.8≤a1≤1.2, 0.5≤x1≤0.65, 0≤y1<0.13, 0.23<z1≤0.5, 0≤b1≤0.1, 0≤c1<0.1, x1+y1+z1+b1=1, and G is at least one of Mg, Ca, Ce, Y, Al, Sn, Ti, Zr, W, Sr, La, Ba, Co, Mo, Cr, and B; D is at least one of N, F, S, Cl, Br, and I;
and/or,
the second active material has a chemical formula of Liₐ₂(Niₓ₂Co_{y2}Mn_{z2}M_{b2})O_{2-c2}E_{c2}, wherein 0.8≤a2≤1.2, 0.75≤x2<1, 0<y2<0.13, 0<z2≤0.25, 0≤b2≤0.1, 0≤c1≤0.1, x2+y2+z2+b2=1, and M is at least one of Mg, Ca, Ce, Y, Al, Sn, Ti, Zr, W, Sr, La, Ba, Co, Mo, Cr, and B; E is at least one of N, F, S, Cl, Br, and I;
and/or,
the third active material has a chemical formula of LiFe_{1-x3-y3}Mnₓ₃M′_{y3}PO₄, wherein 0≤x3≤1, 0≤y3≤0.1, 0≤x3+y3≤1, M′ is selected from at least one of transition metal elements and non-transition metal elements other than Fe and Mn.

In optional embodiments, in the cathode active material, a mass percentage of the first active material is 40-96%, a mass percentage of the second active material is 2-30%, and a mass percentage of the third active material is 2-30%;
and/or,
a mass percentage content of the third active material in the cathode active material is w, a volume resistivity of powder of the cathode active material under a pressure of 20 MPa is R, and w and R satisfy 0.025≤1000×w/R≤500.

In optional embodiments, the first active material and the second active material are in the form of particles, and the form of particles both selects one of monocrystalline particles, polycrystalline particles, or a mixture of monocrystalline and polycrystalline particles.

In optional embodiments, the particle size of the first active material satisfies Dv10≥0.5 μm, and 1 μm≤Dv50≤7 μm;
and/or,
the particle size of the second active material satisfies Dv10≥1.0 μm, and 2 μm≤Dv50≤10 μm;
and/or,
the particle size of the third active material satisfies that Dv50 is in the range of 0.2 μm-10 μm;
and/or,
primary particles D_{A} of the third active material are in the range of 20-300 nm.

In optional embodiments, the third active material is at least one of dope-modified LiFePO₄ or LiMn₁₋ₓ₄Feₓ₄PO₄; wherein when the third active material comprises LiMn₁₋ₓ₄Feₓ₄PO₄, 0<x4<1;
and/or,
the surface of the third active material has a carbon coating layer, and the mass percentage of the carbon coating layer in the third active material is 0.1%-5%.

In optional embodiments, in the cathode film, the mass percentage content of the cathode active material is 90%-99.5%;
and/or,
the cathode film also comprises a conductive agent, a binder and a solvent, and the weight ratio of the cathode active material, the conductive agent and the binder is (90-99): (1-5): (1-5).

In optional embodiments, the cathode plate has a compaction density of 3.1 g/cm³-3.8 g/cm³;
and/or,
the cathode plate has a volume resistivity of Rs≤50 kΩ·cm.

According to a second aspect, some embodiments of the present disclosure provide a method for preparing the cathode plate of any one of the embodiments above, comprising:
uniformly mixing a cathode active material, a conductive agent and a binder, and dispersing same in a solvent to form a cathode active slurry; and
coating the cathode active slurry on at least one surface of a cathode current collector, performing drying and cold pressing, and then forming a cathode film on a surface of the cathode current collector.

According to a third aspect, some embodiments of the present disclosure provide a lithium ion battery, comprising the cathode plate according to any one of the embodiments above; or, comprising a cathode plate prepared by the method for preparing a cathode plate of the embodiments above.

The embodiments of the present disclosure at least have the following advantages or beneficial effects:

On the one hand, by cooperation of the medium-nickel low-cobalt or cobalt-free transition metal material and the high-nickel transition metal material, the energy density, low-temperature dynamic performance and cycle performance of the material can be improved to a certain extent; furthermore, by the addition of the phosphate material having high safety performance, the phosphate material can be distributed among layered transition metal oxide particles, which can improve the thermal stability of the cathode material, thereby improving the safety of the material; on the other hand, the phosphate material and the layered transition metal material have different discharge plateaus, and have an obvious discharge plateau at a low SOC after being compounded, which can improve the low-temperature power performance of the material and prolong the time of low-temperature discharge.

Embodiments of the present disclosure further provide a preparation method for a cathode plate, which can quickly prepare the cathode plate above.

Embodiments of the present disclosure further provide a lithium ion battery, which comprises the cathode plate above. Therefore, the lithium ion battery also has the advantages of high energy density, excellent cycle performance and low-temperature power performance, and high safety performance.

### BRIEF DESCRIPTION OF THE DRAWINGS

In order to illustrate technical solutions of embodiments of the present disclosure more clearly, hereinafter, accompanying drawings requiring to be used in the embodiments will be briefly introduced. It should be understood that the following accompanying drawings only illustrate certain embodiments of the present disclosure, and therefore shall not be considered as limiting the scope. For a person of ordinary skill in the art, other related accompanying drawings may also be obtained according to these accompany drawings without any inventive effort.

FIG. 1 relates to a 0.33 C discharge curve at 25° C. of lithium ion batteries provided according to Examples 1-2 and Comparative Examples 1-3 of the present disclosure, and an enlarged diagram of the discharge curve at a discharge tail end;

FIG. 2 is a comparison diagram of discharge curves of lithium ion batteries at −10° C., 10% SOC and 0.6 C provided according to Examples 1, 6 and 8, and Comparative Examples 1-2 of the present disclosure; and

FIG. 3 is a relational graph of temperature vs. heat flow during a DSC test of a cathode plate when a lithium ion battery is fully charged provided according to Examples 1 and 3 and Comparative Examples 1-3 of the present disclosure.

### DETAILED DESCRIPTION OF THE EMBODIMENTS

To make the object, technical solutions, and advantages of the embodiments of the present disclosure clearer, hereinafter, the technical solutions in the embodiments of the present disclosure will be clearly and completely described. If no specific conditions are noted in the examples, the experiments are performed according to conventional conditions or conditions suggested by a manufacturer. If manufacturers for reagents or instruments used are not noted, the reagents or instruments can be conventional products that can be commercially-available.

The features and performance of the present disclosure will be further described in detail below in combination with embodiments.

In the related art, the energy density of a battery can be effectively improved by reasonably proportioning a medium-nickel transition metal oxide material and a high-nickel transition metal oxide material and then taking same as a cathode active material. However, due to the structure problem of the layered transition metal oxide material itself, oxygen is easily released in a high-delithiation state, which deteriorates the stability thereof; in addition, as the nickel content increases, the thermal decomposition temperature decreases, and the heat release amount increases, so that the thermal decomposition temperature and heat release amount of the cathode electrode significantly increase, thereby greatly reducing the safety performance of a cell. That is, the high-nickel transition metal oxide has poor thermal stability, so that the safety performance of the battery is reduced, and the energy density and safety performance of the battery cannot be satisfied at the same time.

In view of this, embodiments of the present disclosure provide a cathode plate and a preparation method therefor, and a lithium ion battery, which can simultaneously ensure the energy density, low-temperature power performance and safety performance of the lithium ion battery. Hereinafter, the cathode plate and the preparation method therefor, and the lithium ion battery are sequentially described in detail.

The cathode plate provided by the embodiments of the present disclosure comprises: a cathode current collector and a cathode film provided on at least one surface of the cathode current collector; wherein the cathode current collector may be selected as an aluminum foil, and the cathode film is preferably coated on two side surfaces of the cathode current collector in a thickness direction; and a cathode active material of the cathode film comprises a first active material, a second active material and a third active material, the first active material is a medium-nickel low-cobalt or cobalt-free transition metal oxide, the second active material is a high-nickel transition metal oxide, and the third active material is a lithium-containing phosphate having an olivine structure.

On the one hand, by cooperation of the medium-nickel low-cobalt or cobalt-free transition metal material and the high-nickel transition metal material, the energy density, low-temperature dynamic performance and cycle performance of the material can be improved to a certain extent; furthermore, on the basis that the medium-nickel low-cobalt or cobalt-free transition metal oxide is blended with the high-nickel layered transition metal oxide, a polyanionic cathode material of an olivine structure phosphate system having an excellent safety performance is added, and the polyanionic cathode material can be distributed between layered transition metal oxide particles, to achieve uniform distribution of materials with different thermal stability, such as high-nickel, medium-nickel, lithium iron phosphate/lithium manganese iron phosphate, so as to improve the thermal stability of the cathode material, thereby improving the safety of the material; on the other hand, the phosphate material and the layered transition metal material have different discharge plateaus, and have an obvious discharge plateau at a low SOC (remaining state of charge) after being compounded, which can improve the low-temperature power performance of the material and prolong the time of low-temperature discharge. That is, by the arrangement of the cathode plate, the low-temperature power performance and the safety performance of the lithium ion battery can be effectively improved while ensuring the energy density and the cycle performance, so that the energy density, low-temperature power performance and safety performance of the battery can be simultaneously ensured.

It should be noted that in the present embodiment, the first active material and the second active material are in the form of particles, and the form of particles both selects one of monocrystalline particles, polycrystalline particles, or a mixture of monocrystalline and polycrystalline particles, and exemplarily, the first active material and the second active material may be selected as monocrystalline particles. Moreover, the first active material has a chemical formula of Liₐ₁(Niₓ₁Co_{y1}Mn_{z1}G_{b1})O_{2-c1}D_{c1}; wherein 0.8≤a1≤1.2, 0.5≤x1≤0.65, 0≤y1<0.13, 0.23<z1≤0.5, 0≤b1≤0.1, 0≤c1<0.1, x1+y1+z1+b1=1, and G is at least one of Mg, Ca, Ce, Y, Al, Sn, Ti, Zr, W, Sr, La, Ba, Co, Mo, Cr, and B; D is at least one of N, F, S, Cl, Br, and I. When the value range of x1 is 0.5≤x1≤0.65, the first active material is a medium-nickel material; when y1=0, the first active material is a medium-nickel cobalt-free transition metal oxide; and when y1 is greater than 0, the first active material is a medium-nickel low-cobalt transition metal oxide. By doping the first active material with the G element and the D element, it is convenient to cooperate with the second active material, so as to improve the energy density and cycle performance of the material.

The second active material has a chemical formula of Liₐ₂(Niₓ₂Co_{y2}Mn_{z2}M_{b2})O_{2-c2}E_{c2}; wherein 0.8≤a2≤1.2, 0.75≤x2<1, 0<y2<0.13, 0<z2≤0.25, 0≤b2≤0.1, 0≤c1≤0.1, x2+y2+z2+b2=1, and M is at least one of Mg, Ca, Ce, Y, Al, Sn, Ti, Zr, W, Sr, La, Ba, Co, Mo, Cr, and B; E is at least one of N, F, S, Cl, Br, and I. When the value of x2 is in the range of 0.75≤x2<1, the second active material is a high-nickel transition metal oxide. By doping the second active material with the M element and the E element, it is convenient to cooperate with the first active material, so as to improve the energy density and cycle performance of the material.

The third active material has a chemical formula of LiFe_{1-x3-y3}Mnₓ₃M′_{y3}PO₄, wherein 0≤x3≤1, 0≤y3≤0.1, 0≤x3+y3≤1, M′ is selected from at least one of transition metal elements and non-transition metal elements other than Fe and Mn, and exemplarily, the third active material may be one or more of lithium iron phosphate and lithium manganese iron phosphate. That is, the third active material is at least one of dope-modified LiFePO₄ or LiMn₁₋ₓ₄Feₓ₄PO₄; wherein when the third active material comprises LiMn₁₋ₓ₇Feₓ₄PO₄, 0<x4<1. The olivine structure phosphate cathode material has the characteristics of high stability and high safety performance, and can be uniformly distributed in gaps between the layered transition metal oxide particles during the preparation of the cathode plate, to achieve uniform distribution of materials with different thermal stability, such as high-nickel, medium-nickel, lithium iron phosphate/lithium manganese iron phosphate, so as to achieve the object of omnidirectional blocking and mitigating thermal runaway of high-nickel components with the worst thermal stability in the case of a low addition amount, thereby improving the structural stability and safety of the cathode system.

It should be further noted that, in the present embodiment, in the cathode active material, a mass percentage of the first active material is 40-96%, a mass percentage of the second active material is 2-30%, and a mass percentage of the third active material is 2-30%. Exemplarily, a mass percentage of the first active material is 50-90%, a mass percentage of the second active material is 5-25%, and a mass percentage of the third active material is 5-25%. By controlling the proportion of the third active material within this range, not only can the cycle performance and energy density of the battery be ensured, but also the low-temperature power performance and safety performance of the battery can be greatly improved, thereby more comprehensively improving the comprehensive electrochemical performance of the lithium ion battery.

In addition, it should also be noted that in the embodiments of the present disclosure, a mass percentage content of the third active material in the cathode active material is w, a volume resistivity of powder of the cathode active material under a pressure of 20 MPa is R, and w and R satisfy 0.025≤1000×w/R≤500. By defining the mass percentage content of the third active material and the resistivity of the cathode active material, it can be ensured that the prepared cathode plate has an obvious discharge plateau at a low SOC, which can effectively increase the discharge power of the material in a low SOC at a low temperature, prolong the SOC discharge time, and fully improve the low-temperature power performance of the lithium ion battery.

As an optional solution, in the embodiments of the present disclosure, the particle size of the first active material satisfies Dv10≥0.5 μm and 1 μm≤Dv50≤7 μm, the particle size of the second active material satisfies Dv10≥1.0 μm and 2 μm≤Dv50≤10 μm, and the particle size of the third active material satisfies that Dv50 is the range 0.2 μm-10 μm. By limiting the particle sizes of the first active material, the second active material, and the third active material, the third active material can be easily distributed in gaps of particles of the first active material and the second active material, to achieve uniform distribution of materials with different thermal stability, such as high-nickel, medium-nickel, lithium iron phosphate/lithium manganese iron phosphate, so as to achieve the object of omnidirectional blocking and mitigating thermal runaway of high-nickel components with the worst thermal stability in the case of a low addition amount, thereby improving the structural stability and safety of the cathode system.

Further, optionally, in the embodiments of the present disclosure, primary particles D_{A} of the third active material is in the range of 20-300 nm, preferably, primary particles D_{A} of the third active material are in the range of 50 to 200 nm, and exemplarily, may be selected as 200 nm. Nanoscale lithium iron phosphate/lithium manganese iron phosphate can achieve a better filling effect, thereby increasing the filling amount of the cathode material in the battery, and facilitating increase of the compaction density of the lithium ion battery; improving the utilization rate of the active material finally improves the capacity and cycle performance of the composite cell, to further improve the comprehensive electrochemical performance of the lithium ion battery. Furthermore, when primary particles of lithium iron phosphate/lithium manganese iron phosphate are relatively large, the low-temperature performance of the material itself is relatively poor, and a relatively high blending amount is required to obviously improve the low-temperature power performance, which greatly reduces the energy density of the cathode; therefore, selecting the primary particles to be in the range of 20-300 nm, especially in the range of 50-200 nm can more effectively ensure various electrochemical properties of the material.

Still further, the surface of the third active material has a carbon coating layer, and the mass percentage of the carbon coating layer in the third active material is 0.1%-5%. Since the phosphate system itself has a poor conductivity, a nanoscale carbon thin film coated on the surface thereof can not only improve the interface charge transfer capability of a LiFePO₄ electrode, but also improve the electron transfer capability of the layered transition metal oxide, improve the conductivity of a composite electrode, reduce the interface impedance of the electrode, and further improve the comprehensive electrochemical performance of the lithium ion battery.

It should be noted that in the present embodiment, the cathode film is obtained by coating a cathode active slurry on the cathode current collector, and then performing drying and cold pressing. In the cathode film, the mass percentage content of the cathode active material is 90%-99.5%, preferably 94%-99%, so as to fully ensure the performance of the material. Moreover, in addition to comprising the cathode active material, the cathode active slurry also comprises a conductive agent, a binder and a solvent. The conductive agent comprises at least one of conductive carbon black, conductive graphite, carbon nanotubes, carbon nanofibers and graphene, and exemplarily, the conductive agent can select conductive carbon black. The binder can be selected from at least one of styrene-butadiene rubber, polyvinylidene fluoride, polytetrafluoroethylene, polyacrylonitrile, sodium carboxymethyl cellulose, polyvinyl alcohol, and polymethyl methacrylate. Exemplarily, the binder can be selected as polyvinylidene fluoride. The solvent may be selected as N-methylpyrrolidone. Furthermore, the weight ratio of the cathode active material, the conductive agent and the binder is (90-99): (1-5): (1-5), and exemplarily, the ratio of the cathode active material, the conductive carbon black and polyvinylidene fluoride may be selected as 96:3:1. During the preparation of the cathode plate, the cathode active material, the conductive agent and the binder may be first uniformly mixed, then dispersed into the solvent to form a cathode active slurry, and the cathode active slurry is coated on the cathode current collector, and then dried and cold-pressed.

As an optional solution, in the embodiments of the present disclosure, the cathode plate has a compaction density of 3.1 g/cm³-3.8 g/cm³. The cathode plate has a volume resistivity of Rs≤50 kΩ·cm. By controlling the compaction density and volume resistivity of the cathode plate, the performance of the material can be further ensured, so as to improve the comprehensive electrochemical performance of the battery.

Embodiments of the present disclosure further provide a preparation method for the cathode plate, comprising:

S1: uniformly mixing a cathode active material, a conductive agent and a binder, and dispersing same in a solvent to form a cathode active slurry; and

S2: coating the cathode active slurry on at least one surface of a cathode current collector, performing drying and cold pressing, and then forming a cathode film on a surface of the cathode current collector.

In detail, in step S1, the weight ratio of the cathode active material, the conductive agent, and the binder is (90-99): (1-5): (1-5), and exemplarily may be selected to be 96:3:1. In step S2, the cathode active slurry are coated on both two side surfaces of the cathode current collector. The preparation method can quickly prepare the cathode plate above.

Embodiments of the present disclosure further provide a lithium ion battery, which comprises the cathode plate above. Therefore, the lithium ion battery also has the advantages of high energy density, excellent cycle performance and low-temperature power performance, and high safety performance.

In detail, the lithium ion battery further comprises a housing, a separator, a anode plate and an electrolyte. The cathode plate, the separator and the anode plate are successively arranged in a stacked manner, and then a bare cell is formed by lamination or winding, and after the bare cell is installed in the housing, the electrolyte is injected, and after sealing, the lithium ion battery can be obtained.

More specifically, the electrolyte is a 1M solution prepared by mixing ethylene carbonate, methyl ethyl carbonate and diethyl carbonate at a volume ratio of 1:1:1 and then adding LiPF₆. The separator may be selected as one of a polyethylene film, a polypropylene film and a composite film formed by polyethylene and polypropylene. Exemplarily, a PE separator may be selected. The anode plate is obtained by coating a anode active slurry on a anode current collector, and then performing drying and cold pressing. The anode current collector may be selected as a copper foil. The anode active slurry comprises a anode active material, a conductive agent, a binder and a solvent; the anode active material can be selected as graphite, the conductive agent can be selected as conductive carbon black, a dispersant can be selected as carboxymethyl cellulose, and the binder can be selected as styrene-butadiene rubber. The solvent may be selected as deionized water. When preparing the anode plate, a anode active material, i.e. graphite, conductive carbon, carboxymethyl cellulose (CMC), and a binder i.e. styrene-butadiene rubber (SBR) are sufficiently stirred and mixed at a weight ratio of 95:2:1.5:1.5 in an appropriate amount of water solvent, such that they form a uniform anode slurry. Then, the anode active slurry is coated on a anode current collector, i.e. a Cu foil, and after drying, an electrode plate is cold pressed to designed compaction, and is split into strips to obtain the anode plate.

During assembling of the battery, the cathode plate, the separator and the anode plate are stacked in sequence, so that the separator is located between the cathode plate and the anode plate to achieve a separation effect, and it is ensured that the film surface size of the anode plate is larger than that of the cathode plate, and the three are wound or laminated to form a bare cell. A cathode tab and a anode tab are fixed by welding to form a bare cell which is placed in an outer packaging housing, dried and then injected with an electrolyte. Finally, after processes of formation and capacity division, etc. and complete sealing, a lithium ion battery is obtained.

Hereinafter, the performance of the lithium ion battery provided in the embodiments of the present disclosure is described in detail by Examples, Comparative Examples, and Experimental Examples.

### EXAMPLE 1

The present embodiment provides a lithium ion battery, which is prepared in the following manner:

S1: preparing a cathode plate, specifically comprising the following steps:
taking a first active material LiNi_{0.6}Co_{0.05}Mno_{0.35}O₂ having Dv10 of 0.5 μm and Dv50 of 4 μm, a second active material LiNi_{0.83}Co_{0.12}Mn_{0.05} having Dv10 of 1.0 μm and Dv50 of 5 μm, and a third active material LFP-1 having Dv50 of 3 μm and primary particles of 0.1 μm as a cathode active material for use; mixing the first active material, the second active material, the third active material, conductive carbon black, and polyvinylidene fluoride at a weight ratio of 76.8:14.4:4.8:3:1, dispersing same in an N-methylpyrrolidone solvent system and uniformly stirring, to obtain a cathode active slurry; and coating the cathode active slurry on a cathode current collector, i.e. an aluminum foil, drying and cold pressing to obtain a cathode plate;

S2: preparing a anode plate, specifically comprising the following steps:
uniformly mixing a anode active material, i.e. graphite with conductive carbon, a dispersant, i.e. carboxymethyl cellulose (CMC) and a binder, i.e. styrene-butadiene rubber (SBR) at a weight ratio of 95:2:1.5:1.5, and then uniformly dispersing same in an appropriate amount of a water solvent, so as to obtain a anode active slurry; coating the anode active slurry on a anode current collector, i.e. a copper foil, and drying and cold pressing to obtain a anode plate.

S3: preparing an electrolyte, specifically comprising the following steps:
mixing ethylene carbonate, methyl ethyl carbonate and diethyl carbonate at a volume ratio of 1:1:1, and adding LiPF6 to prepare a 1M solution, for standby use as an electrolyte.

S4: assembling a battery, specifically comprises the following steps:
selecting a PE separator as a separator, stacking the cathode plate, the separator and the anode plate in sequence, so that the separator is located between the cathode plate and the anode plate to achieve a separation effect, and it is ensured that the film surface size of the anode plate is larger than that of the cathode, and performing winding to form a bare cell; and fixing a cathode tab and a anode tab by welding to form the bare cell which is placed in an outer packaging housing, performing drying and then injecting the electrolyte. Finally, after processes of formation and capacity division, etc. and complete sealing, a lithium ion battery is obtained.

### EXAMPLE 2

The present example provides a lithium ion battery, and a preparation method therefor differs from that of Example 1 in that:
in step S1, the proportion of the first active material in the cathode active material is 75%, the proportion of the second active material in the cathode active material is 15%, and the proportion of the third active material in the cathode active material is 10%.

### EXAMPLE 3

The present example provides a lithium ion battery, and a preparation method therefor differs from that of Example 1 in that:
in step S1, the proportion of the first active material in the cathode active material is 70%, the proportion of the second active material in the cathode active material is 15%, and the proportion of the third active material in the cathode active material is 15%.

### EXAMPLE 4

The present example provides a lithium ion battery, and a preparation method therefor differs from that of Example 1 in that:
in step S1, the proportion of the first active material in the cathode active material is 80%, the proportion of the second active material in the cathode active material is 10%, and the proportion of the third active material in the cathode active material is 10%.

### EXAMPLE 5

The present example provides a lithium ion battery, and a preparation method therefor differs from that of Example 1 in that:
in step S1, the proportion of the first active material in the cathode active material is 80%, the proportion of the second active material in the cathode active material is 5%, and the proportion of the third active material in the cathode active material is 15%.

### EXAMPLE 6

The present example provides a lithium ion battery, and a preparation method therefor differs from that of Example 1 in that:
in step S1, the primary particle size of the third active material LFP-2 is 0.2 μm.

### EXAMPLE 7

The present example provides a lithium ion battery, and a preparation method therefor differs from that of Example 1 in that:
in step S1, the primary particle size of the third active material LFP-2 is 0.2 μm, the proportion of the first active material in the cathode active material is 75%, the proportion of the second active material in the cathode active material is 15%, and the proportion of the third active material in the cathode active material is 10%.

### EXAMPLE 8

The present example provides a lithium ion battery, and a preparation method therefor differs from that of Example 1 in that:
in step S1, the primary particle size of the third active material LFP-3 is 0.3 μm.

### EXAMPLE 9

The present example provides a lithium ion battery, and a preparation method therefor differs from that of Example 1 in that:
in step S1, the primary particle size of the third active material LFP-3 is 0.3 μm, the proportion of the first active material in the cathode active material is 75%, the proportion of the second active material in the cathode active material is 15%, and the proportion of the third active material in the cathode active material is 10%.

### EXAMPLE 10

The present example provides a lithium ion battery, and a preparation method therefor differs from that of Example 1 in that:
in step S1, the primary particle size of the third active material LFP-3 is 0.3 μm, the proportion of the first active material in the cathode active material is 65%, the proportion of the second active material in the cathode active material is 15%, and the proportion of the third active material in the cathode active material is 20%.

### EXAMPLE 11

The present example provides a lithium ion battery, and a preparation method therefor differs from that of Example 1 in that:
in step S1, the primary particle size of the third active material LFMP-1 is 0.1 μm, the proportion of the first active material in the cathode active material is 70%, the proportion of the second active material in the cathode active material is 15%, and the proportion of the third active material in the cathode active material is 15%.

### EXAMPLE 12

The present example provides a lithium ion battery, and a preparation method therefor differs from that of Example 1 in that:
in step S1, the primary particle size of the third active material LFMP-1 is 0.1 μm, the proportion of the first active material in the cathode active material is 60%, the proportion of the second active material in the cathode active material is 15%, and the proportion of the third active material in the cathode active material is 25%.

### EXAMPLE 13

The present example provides a lithium ion battery, and a preparation method therefor differs from that of Example 1 in that:
in step S1, the first active material is LiNi_{0.65}Mn_{0.35}O₂.

### EXAMPLE 14

The present example provides a lithium ion battery, and a preparation method therefor differs from that of Example 1 in that:
in step S1, the first active material is LiNi_{0.65}Mn_{0.35}O₂, the proportion of the first active material in the cathode active material is 75%, the proportion of the second active material in the cathode active material is 15%, and the proportion of the third active material in the cathode active material is 10%.

### EXAMPLE 15

The present example provides a lithium ion battery, and a preparation method therefor differs from that of Example 1 in that:
in step S1, the first active material is LiNi_{0.65}Mn_{0.35}O₂, the third active material is LFMP-1, the proportion of the first active material in the cathode active material is 70%, the proportion of the second active material in the cathode active material is 15%, and the proportion of the third active material in the cathode active material is 15%.

### EXAMPLE 16

The present example provides a lithium ion battery, and a preparation method therefor differs from that of Example 1 in that:
in step S1, the first active material is LiNi_{0.55}Co_{0.05}Mn_{0.35}O₂, and the second active material is LiNi_{0.75}Co_{0.15}Mn_{0.1}O₂.

### EXAMPLE 17

The present example provides a lithium ion battery, and a preparation method therefor differs from that of Example 1 in that:
in step S1, the first active material is LiNi_{0.55}Co_{0.05}Mn_{0.35}O₂, and the second active material is LiNi_{0.90}Co_{0.07}Mn_{0.03}O₂.

### Comparative Example 1

Comparative Example 1 provides a lithium ion battery, and a preparation method therefor differs from that of Example 1 in that:
in step S1, the cathode active material only comprises 100% of LiNi_{0.6}Co_{0.05}Mn_{0.35}O₂.

### Comparative Example 2

Comparative Example 2 provides a lithium ion battery, and a preparation method therefor differs from that of Example 1 in that:

in step S1, the cathode active material only comprises a first active material and a second active material, wherein the proportion of the first active material in the cathode active material is 80%, the first active material has a chemical formula of LiNi_{0.6}Co_{0.05}Mn_{0.35}O₂, and the proportion of the second active material in the cathode active material is 20%, and the second active material has a chemical formula of LiNi_{0.83}Co_{0.12}Mn_{0.35}O₂.

### Comparative Example 3

Comparative Example 3 provides a lithium ion battery, and a preparation method therefor differs from that of Example 1 in that:
in step S1, the cathode active material only comprises a first active material and a second active material, wherein the proportion of the first active material in the cathode active material is 85%, the first active material has a chemical formula of LiNi_{0.6}Co_{0.05}Mn_{0.35}O₂, and the proportion of the second active material in the cathode active material is 15%, and the second active material has a chemical formula of LiNi_{0.83}Co_{0.12}Mn_{0.05}O₂.

### Comparative Example 4

Comparative Example 4 provides a lithium ion battery, and a preparation method therefor differs from that of Example 1 in that:

in step S1, the cathode active material only comprises a second active material and a third active material, the proportion of the second active material in the cathode active material is 90%, the second active material has a chemical formula of LiNi_{0.83}Co_{0.12}Mn_{0.05}O₂, and the third active material is LFP-1 and the proportion thereof in the cathode active material is 10%.

### Comparative Example 5

Comparative Example 5 provides a lithium ion battery, and a preparation method therefor differs from that of Example 1 in that:
in step S1, the cathode active material only comprises a first active material and a second active material, wherein the proportion of the first active material in the cathode active material is 85%, the first active material has a chemical formula of LiNi_{0.65}Mn_{0.35}O₂, and the proportion of the second active material in the cathode active material is 15%, and the second active material has a chemical formula of LiNi_{0.83}Co_{0.12}Mn_{0.35}O₂.

### Comparative Example 6

Comparative Example 6 provides a lithium ion battery, and a preparation method therefor differs from that of Example 1 in that:
in step S1, the cathode active material only comprises a first active material and a second active material, wherein the proportion of the first active material in the cathode active material is 85%, the first active material has a chemical formula of LiNi_{0.55}Co_{0.05}Mn_{0.35}O₂, and the proportion of the second active material in the cathode active material is 15%, and the second active material has a chemical formula of LiNi_{0.75}Co_{0.15}Mn_{0.1}O₂.

### Comparative Example 7

Comparative Example 7 provides a lithium ion battery, and a preparation method therefor differs from that of Example 1 in that:
in step S1, the cathode active material only comprises a first active material and a second active material, wherein the proportion of the first active material in the cathode active material is 85%, the first active material has a chemical formula of LiNi_{0.55}Co_{0.05}Mn_{0.35}O₂, and the proportion of the second active material in the cathode active material is 15%, and the second active material has a chemical formula of LiNi_{0.90}Co_{0.08}Mn_{0.02}O₂.

To facilitate illustration of differences between Examples and Comparative Examples, parameter information of Examples 1-17 and Comparative Examples 1-9 is summarized in Table 1.

TABLE 1
Parameter Information

| | Medium-nickel low-cobalt | | | | Phosphate cathode | | |
|---|---|---|---|---|---|---|---|
| | or cobalt-free cathode | | High-nickel cathode | | | | Primary |
| | First active | Mass | Second active | Mass | Third active | Mass | particles |
| Item | material | proportion | material | proportion | material | proportion | (μm) |
| Example 1 | LiNi_{0.6}Co_{0.05}Mn_{0.35}O₂ | 80% | LiNi_{0.83}Co_{0.12}Mn_{0.05}O₂ | 15% | LFP-1 | 5% | 0.10 |
| Example 2 | LiNi_{0.6}Co_{0.05}Mn_{0.35}O₂ | 75% | LiNi_{0.83}Co_{0.12}Mn_{0.05}O₂ | 15% | LFP-1 | 10% | 0.10 |
| Example 3 | LiNi_{0.6}Co_{0.05}Mn_{0.35}O₂ | 70% | LiNi_{0.83}Co_{0.12}Mn_{0.05}O₂ | 15% | LFP-1 | 15% | 0.10 |
| Example 4 | LiNi_{0.6}Co_{0.05}Mn_{0.35}O₂ | 80% | LiNi_{0.83}Co_{0.12}Mn_{0.05}O₂ | 10% | LFP-1 | 10% | 0.10 |
| Example 5 | LiNi_{0.6}Co_{0.05}Mn_{0.35}O₂ | 80% | LiNi_{0.83}Co_{0.12}Mn_{0.05}O₂ | 5% | LFP-1 | 15% | 0.10 |
| Example 6 | LiNi_{0.6}Co_{0.05}Mn_{0.35}O₂ | 80% | LiNi_{0.83}Co_{0.12}Mn_{0.05}O₂ | 15% | LFP-2 | 5% | 0.20 |
| Example 7 | LiNi_{0.6}Co_{0.05}Mn_{0.35}O₂ | 75% | LiNi_{0.83}Co_{0.12}Mn_{0.05}O₂ | 15% | LFP-2 | 10% | 0.20 |
| Example 8 | LiNi_{0.6}Co_{0.05}Mn_{0.35}O₂ | 80% | LiNi_{0.83}Co_{0.12}Mn_{0.05}O₂ | 15% | LFP-3 | 5% | 0.30 |
| Example 9 | LiNi_{0.6}Co_{0.05}Mn_{0.35}O₂ | 75% | LiNi_{0.83}Co_{0.12}Mn_{0.05}O₂ | 15% | LFP-3 | 10% | 0.30 |
| Example 10 | LiNi_{0.6}Co_{0.05}Mn_{0.35}O₂ | 65% | LiNi_{0.83}Co_{0.12}Mn_{0.05}O₂ | 15% | LFP-3 | 20% | 0.30 |
| Example 11 | LiNi_{0.6}Co_{0.05}Mn_{0.35}O₂ | 70% | LiNi_{0.83}Co_{0.12}Mn_{0.05}O₂ | 15% | LFMP-1 | 15% | 0.10 |
| Example 12 | LiNi_{0.6}Co_{0.05}Mn_{0.35}O₂ | 60% | LiNi_{0.83}Co_{0.12}Mn_{0.05}O₂ | 15% | LFMP-1 | 25% | 0.10 |
| Example 13 | LiNi_{0.65}Mn_{0.35}O₂ | 80% | LiNi_{0.83}Co_{0.12}Mn_{0.05}O₂ | 15% | LFP-1 | 5% | 0.10 |
| Example 14 | LiNi_{0.65}Mn_{0.35}O₂ | 75% | LiNi_{0.83}Co_{0.12}Mn_{0.05}O₂ | 15% | LFP-1 | 10% | 0.10 |
| Example 15 | LiNi_{0.65}Mn_{0.35}O₂ | 70% | LiNi_{0.83}Co_{0.12}Mn_{0.05}O₂ | 15% | LFMP-1 | 15% | 0.10 |
| Example 16 | LiNi_{0.55}Co_{0.05}Mn_{0.35}O₂ | 80% | LiNi_{0.75}Co_{0.15}Mn_{0.1}O₂ | 15% | LFP-1 | 5% | 0.10 |
| Example 17 | LiNi_{0.55}Co_{0.05}Mn_{0.35}O₂ | 80% | LiNi_{0.90}Co_{0.07}Mn_{0.03}O₂ | 15% | LFP-1 | 5% | 0.10 |
| Comparative | LiNi_{0.6}Co_{0.05}Mn_{0.35}O₂ | 100% | / | / | / | / | / |
| Example 1 | | | | | | | |
| Comparative | LiNi_{0.6}Co_{0.05}Mn_{0.35}O₂ | 80% | LiNi_{0.83}Co_{0.12}Mn_{0.05}O₂ | 20% | / | / | / |
| Example 2 | | | | | | | |
| Comparative | LiNi_{0.6}Co_{0.05}Mn_{0.35}O₂ | 85% | LiNi_{0.83}Co_{0.12}Mn_{0.05}O₂ | 15% | / | / | / |
| Example 3 | | | | | | | |
| Comparative | / | / | LiNi_{0.83}Co_{0.12}Mn_{0.05}O₂ | 90% | LFP-1 | 10% | 0.10 |
| Example 4 | | | | | | | |
| Comparative | LiNi_{0.65}Mn_{0.35}O₂ | 85% | LiNi_{0.83}Co_{0.12}Mn_{0.05}O₂ | 15% | / | / | / |
| Example 5 | | | | | | | |

### Experimental Example 1

The lithium ion batteries provided in Examples 1-2 and Comparative Examples 1-3 were subjected to a charge and discharge test at 25° C. and 0.33 C, and a discharge curve thereof and an enlarged diagram of the discharge curve at a discharge tail end are shown in FIG. 1. According to the results as shown in FIG. 1, it can be determined that the lithium ion batteries provided by the examples of the present disclosure have an obvious discharge plateau after a discharge voltage is less than 3.3V, and the discharge capacity ratio of the plateau is greater than 3% when a cutoff voltage is 2.8V.

### Experimental Example 2

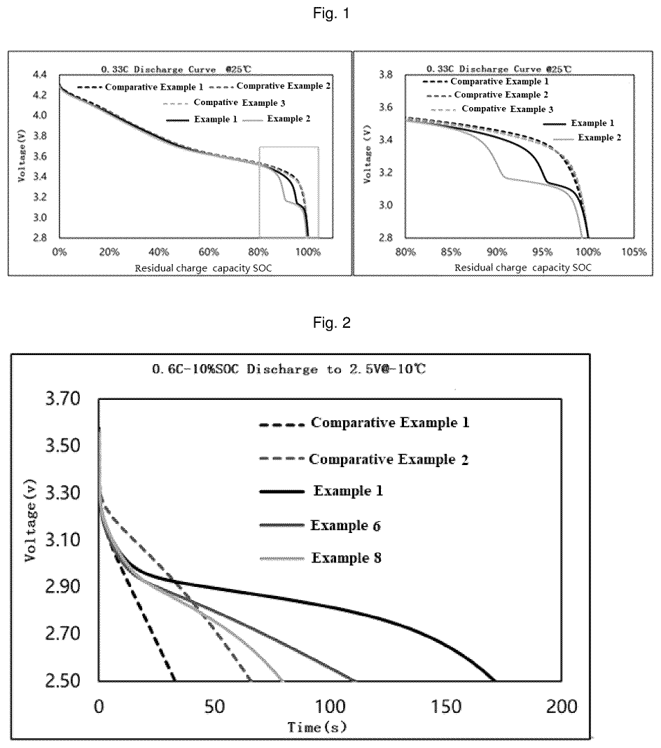

The lithium ion batteries of Examples 1, 6 and 8 and Comparative Examples 1-2 were subjected to a discharge test at −10° C., 10% SOC and 0.6 C, and a comparison diagram of discharge curves thereof is shown in FIG. 2. According to the result shown in FIG. 2, it can be determined that the lithium ion batteries provided in the examples of the present disclosure have an obvious discharge plateau at a low SOC, which can increase the discharge power at a low temperature and a low SOC, thereby prolonging the discharge time at a low temperature and a low SOC.

### Experimental Example 3

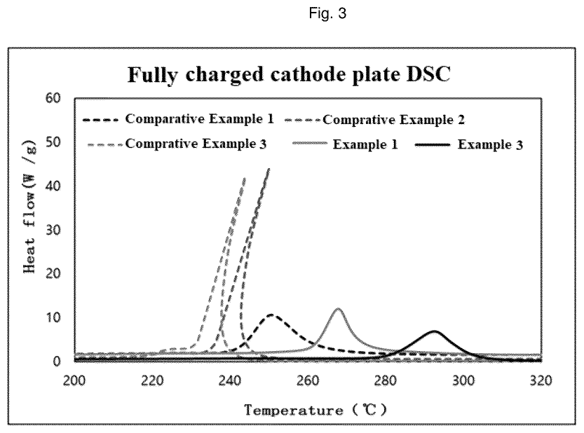

When each of the lithium ion batteries provided in Examples 1-2 and Comparative Examples 1-3 is fully charged, a DSC test was performed on the cathode plate of each lithium ion battery, and the relationship between temperature and heat flow of the DSC test is as shown in FIG. 3. According to the results in FIG. 3, it can be determined that a DSC exothermic initial temperature of the lithium ion batteries provided in the Examples of the present disclosure can reduce by 30° C. or more compared with those in the Comparative Examples 1-3, which can effectively improve the safety performance.

### Experimental Example 4

The capacity per gram, cathode mass energy density, discharge time at −10° C., cycle capacity retention ratio at 45° C., DSC exothermic initial temperature, enthalpy, maximum needle punch temperature, and needle punch pressure of the cathode plate of each of the lithium ion batteries prepared in Examples 1-17 and Comparative Examples 1-7 were tested.

A test process of the capacity per gram and the mass energy density of the cathode is: at 25° C., the battery was charged to 4.35V at a constant current and constant voltage of ⅓ C, a cutoff current being 0.05 C; after standing for 15 min, the battery was discharged to 2.8V at a constant current of ⅓ C to obtain ⅓ of discharge capacity and an average discharge voltage; the capacity per gram is the ⅓ of discharge capacity divided by the weight of the cathode active material; and the mass energy density of the cathode is the capacity per gram multiplied by the average discharge voltage.

A test process of the discharge time at −10° C. is: at 25° C., the battery was charged to 4.35V at a constant current and constant voltage of 1 C, a cutoff current being 0.05 C, and after standing for 15 minutes, the battery was discharged to 2.8V at 1 C, the discharge capacity being denoted as C₀; the battery was charged to 4.35V at a constant current and constant voltage of 1 C₀, the cutoff current being 0.05 C; and after standing for 5 minutes, the battery was discharged at 1 C₀ for 54 minutes to adjust to 10% SOC. The battery was placed in a thermotank at −10° C. for standing still for 1 hour, and then discharged at a constant current of 0.66 C₀, and the discharge time to a cutoff voltage of 2.5V was denoted as the discharge time at −10° C. and 10% SOC.

A test process of the cycle capacity retention ratio at 45° C. is: in an environment of 45° C., the battery was charged to 4.35V at a constant current and constant voltage of 1 C, a cutoff current being 0.05 C; and after standing still for 15 minutes, the battery was discharged to 2.8V at a constant current of 1 C, and the discharge capacity of the first cycle was denoted as C1; then, 1000 charge and discharge cycles were performed, and the discharge capacity at the 1000-th cycle was denoted as C1000, wherein C1000/C1×100% was denoted as the discharge capacity retention ratio of 1000 cycles of the lithium ion battery.

A test process of the DSC exothermic initial temperature and enthalpy is: a button battery was charged to 4.35V at a 0.1 C rate. Then, the button battery was disassembled in a drying chamber, a cathode plate was taken out and put into a beaker filled with dimethyl carbonate (DMC) for cleaning three times, and then put into a vacuum standing box of the drying chamber, the vacuum state being maintained at 0.096 MPa, and the battery was dried at 80° C. for 12 h; the dried cathode plate was subjected to powder scraping with a blade in the drying chamber, 5±0.1 mg of the cathode active material powder was weighed and placed into a high-pressure crucible, 1.2±0.02 mg of an electrolyte was added dropwise and then sealed, the sample was heated at a temperature rising rate of 10° C./min, and change data of a heat flow of the sample along with temperature was recorded to obtain a DSC spectrum, and an exothermic initial temperature and an exothermic curve of a main exothermic peak were obtained, and the integral area of the exothermic curve is the enthalpy.

The test process of the maximum needle punch temperature and pressure drop is: at 25° C., the battery was charged to 4.35V at a constant current and constant voltage of 1 C, a cutoff current being 0.05 C, and a needle punch test was started after the battery stood still for 1 h; by using a high-temperature-resistant steel needle with a diameter of φ3 mm (a cone angle of the needle tip being 45-60° , the surface of the needle being smooth, non-corrosive, and having no oxide layer and oil stain, and the needle being provided with a thermocouple collection line), penetrating in a direction perpendicular to the large surface of the battery at a speed of 25 mm/s; wherein the penetration position was preferably close to the geometrical center of the punched surface, the steel needle stayed in the cell to observe whether the battery caught fire or exploded; and in the whole process, the maximum needle punch temperature is the maximum temperature of the steel needle collected by the thermocouple, and the voltage drop was the difference between open-circuit voltages of the battery before needle punch and after withdrawal of the steel needle.

The test results are shown in Table 2.

TABLE 2
Test Results

| | | | | Cycle | | | | |
|---|---|---|---|---|---|---|---|---|
| | | Cathode | Discharge | capacity | DSC | | Maximum | Needle |
| | Capacity | mass | time at −10° | retention | exothermic | | needle | punch |
| | per | energy | C. and 10% | ratio at | initial | | punch | pressure |
| | gram | density | SOC | 45° C. | temperature | Enthalpy | temperature | drop |
| Item | (mAh/g) | (Wh/Kg) | (s) | (%) | (° C.) | (J/g) | (° C.) | (V) |
| Example 1 | 184 | 688 | 170 | 92.5 | 268 | 613 | 66 | 0.42 |
| Example 2 | 182 | 677 | 220 | 92.8 | 279 | 536 | 46 | 0.34 |
| Example 3 | 180 | 665 | 250 | 92.9 | 286 | 486 | 38 | 0.15 |
| Example 4 | 181 | 673 | 224 | 93.2 | 282 | 513 | 41 | 0.21 |
| Example 5 | 178 | 657 | 231 | 93.3 | 286 | 384 | 36 | 0.10 |
| Example 6 | 184 | 684 | 115 | 92.5 | 249 | 668 | 387 | 4.29 |
| Example 7 | 182 | 677 | 153 | 92.6 | 256 | 616 | 84 | 0.64 |
| Example 8 | 184 | 688 | 110 | 92.3 | 246 | 702 | 434 | 4.29 |
| Example 9 | 182 | 677 | 146 | 92.6 | 250 | 687 | 294 | 4.29 |
| Example 10 | 179 | 653 | 182 | 93.7 | 261 | 563 | 49 | 0.36 |
| Example 11 | 180 | 675 | 145 | 92.3 | 269 | 604 | 74 | 0.45 |
| Example 12 | 177 | 665 | 189 | 92.1 | 278 | 526 | 50 | 0.32 |
| Example 13 | 184 | 688 | 158 | 90.5 | 261 | 684 | 84 | 0.54 |
| Example 14 | 182 | 677 | 206 | 91.4 | 273 | 597 | 49 | 0.38 |
| Example 15 | 179 | 673 | 125 | 90.4 | 257 | 548 | 78 | 0.60 |
| Example 16 | 184 | 688 | 171 | 92.6 | 276 | 502 | 48 | 0.35 |
| Example 17 | 185 | 690 | 169 | 89.4 | 271 | 534 | 59 | 0.48 |
| Comparative | 183 | 688 | 33 | 91.7 | 246 | 705 | 457 | 4.29 |
| Example 1 | | | | | | | | |
| Comparative | 187 | 703 | 66 | 91.8 | 234 | 902 | 528 | 4.28 |
| Example 2 | | | | | | | | |
| Comparative | 186 | 699 | 54 | 91.7 | 237 | 838 | 619 | 4.28 |
| Example 3 | | | | | | | | |
| Comparative | 199 | 736 | 229 | 78.0 | 220 | 957 | 541 | 4.29 |
| Example 4 | | | | | | | | |
| Comparative | 186 | 699 | 49 | 84.5 | 231 | 894 | 641 | 4.29 |
| Example 5 | | | | | | | | |
| Comparative | 186 | 699 | 51 | 91.0 | 245 | 791 | 485 | 4.29 |
| Example 6 | | | | | | | | |
| Comparative | 186 | 699 | 49 | 89.0 | 238 | 814 | 557 | 4.29 |
| Example 7 | | | | | | | | |

According to comparison between Examples 1-17 and Comparative Examples 1-7 in Table 2, it can be determined that the cathode active material provided in the examples of the present disclosure can effectively increase the low-temperature discharge time, improve the low-temperature performance, and greatly improve the safety performance while ensuring the gram capacity, energy density and cycle performance.

In detail, according to comparison of Examples 1-3, comparison of Examples 6 and 7, comparison of Examples 8-10, and comparison of Examples 11-12, and 13-14 in Table 2, it can be determined that when the content of the high-nickel material is constant, the higher the proportion of lithium iron phosphate, the more obvious the prolonging of the discharge time at a low temperature and a low SOC, and the larger the improvement on the DSC exothermic initial temperature and the enthalpy of the cathode, and the needle punch temperature rise and the pressure drop are also significantly improved.

According to comparison of Examples 1, 4 and 5 in Table 2, it can be determined that when the content of the medium-nickel material is constant, the higher the proportion of lithium iron phosphate, the more obvious the prolonging of the discharge time at a low temperature and a low SOC, and the larger the improvement on the DSC exothermic initial temperature and the enthalpy of the cathode, and the needle punch temperature rise and the pressure drop are also significantly improved.

According to comparison of Examples 1, 6 and 8 and comparison of Examples 2, 7 and 9 in Table 2, it can be determined when the primary particles D_{A} of the third active material are controlled to be in the range of 20-300 nm, along with the decrease of the particle size of the primary particles, the low-temperature kinetic performance of the material gradually improves, and the needle puncture pressure drop and the maximum needle puncture temperature also gradually decrease, which can fully ensure the comprehensive electrochemical performance of the lithium ion battery. Moreover, when the primary particles D_{A} of the third active material are controlled in the range of 50-200 nm, the comprehensive electrochemical performance of the lithium ion battery is better. The reason is that, when the primary particles of the blended LFP are large, the amount dispersed in the cathode active material is small, and the isolation effect of thermal runaway of the layered transition metal oxide is reduced; in addition, the polarization at a low temperature is relatively large, and the advantage of an LFP discharge plateau in a low SOC region cannot be fully realized.

According to comparison of Examples 11 and 15 in Table 2, it can be determined that the first active material containing a cobalt element and the first active material not containing a cobalt element can both effectively improve the low-temperature performance and safety performance of the battery. According to comparison of Examples 16 and 17 in Table 2, it can be determined that the higher the nickel content of the high-nickel is, the higher the energy density of the lithium ion battery is, but the stability of the material is reduced, so that the safety is reduced.

According to comparison of Example 1, Comparative Examples 1, 2 and 3 in Table 2, it can be determined that the energy density of Example 1 is lower than that of Comparative Example 3, which indicates that the addition of the third active material would lead to a decrease in the capacity per gram and energy density, but after the decrease, the capacity per gram and energy density are almost similar to those of Comparative Example 1 which only contains the first active material. However, the addition of the third active material can effectively increase the low-temperature discharge time and the low-temperature performance, increase the cycle performance, and greatly improve the safety performance.

According to comparison of Comparative Example 1 and Comparative Example 2 in Table 2, it can be determined that the addition of the high-nickel second active material can effectively improve the capacity per gram and energy density, can also prolong the low-temperature discharge time, increase the low-temperature performance, increase the cycle performance in a small range, but the safety performance is slightly reduced.

According to comparison between Example 1 and Comparative Example 4 in Table 2, it can be determined that high-nickel the second active material can improve the capacity per gram and energy density, but after the first active material and the second active material are compounded, the cycle, low-temperature performance and safety performance of the lithium ion battery can be further improved.

According to comparison between Example 1 and Comparative Examples 5-7 in Table 2, it can be determined that the third active material can effectively improve the cycle performance, low-temperature power performance and safety performance of the lithium ion battery.

In summary, on the one hand, in the cathode plate provided by the embodiments of the present disclosure, by cooperation of the medium-nickel low-cobalt or cobalt-free transition metal material and the high-nickel transition metal material, the energy density, low-temperature dynamic performance and cycle performance of the material can be improved to a certain extent; furthermore, by the addition of the phosphate material having high safety performance, the phosphate material can be distributed among layered transition metal oxide particles, which can improve the thermal stability of the cathode material, thereby improving the safety of the material; on the other hand, in the cathode plate provided by the embodiments of the present disclosure, the phosphate material and the layered transition metal material have different discharge plateaus, and have an obvious discharge plateau at a low SOC after being compounded, which can improve the low-temperature power performance of the material and prolong the time of low-temperature discharge. That is, embodiments of the present disclosure provide a cathode plate and a preparation method therefor, and a lithium ion battery, which can simultaneously ensure the energy density, low-temperature power performance and safety performance of the lithium ion battery.

The content above only relates to preferred embodiments of the present disclosure and is not intended to limit the present disclosure. For a person skilled in the art, the present disclosure may have various modifications and variations. Any modifications, equivalent replacements, improvements, etc. made within the spirit and principle of the present disclosure shall all fall within the scope of protection of the present disclosure.

What is claimed is:

1. A cathode plate, comprising:
a cathode current collector and a cathode film provided on at least one surface of the cathode current collector, wherein a cathode active material of the cathode film comprises a first active material, a second active material and a third active material, the first active material is a medium-nickel low-cobalt or cobalt-free transition metal oxide, the second active material is a high-nickel transition metal oxide, and the third active material is a lithium-containing phosphate having an olivine structure;
the first active material has a chemical formula of Liₐ₁(Niₓ₁Co_{y1}Mn_{z1}G_{b1})O_{2-c1}D_{c1}; wherein 0.8≤a1≤1.2, 0.5≤x1≤0.65, 0≤y1<0.13, 0.23<z1≤0.5, 0≤b1≤0.1, 0≤c1<0.1, x1+y1+z1+b1=1, and G is at least one of Mg, Ca, Ce, Y, Al, Sn, Ti, Zr, W, Sr, La, Ba, Co, Mo, Cr, and B; D is at least one of N, F, S, C1, Br, and I;
the second active material has a chemical formula of Liₐ₂(Niₓ₂Co_{y2}Mn_{z2}M_{b2})O_{2-c2}E_{c2}; wherein 0.8≤a2≤1.2, 0.75≤x2<1, 0<y2<0.13, 0<z2≤0.25, 0≤b2≤0.1, 0≤c1≤0.1, x2+y2+z2+b2=1, and M is at least one of Mg, Ca, Ce, Y, Al, Sn, Ti, Zr, W, Sr, La, Ba, Co, Mo, Cr, and B; E is at least one of N, F, S, Cl, Br, and I.

2. The cathode plate according to claim 1, wherein
the third active material has a chemical formula of LiFe_{1-x3-y3}Mnₓ₃M′_{y3}PO₄, wherein 0≤x3≤1, 0≤y3≤0.1, 0≤x3+y3≤1, M′ is selected from at least one of transition metal elements and non-transition metal elements other than Fe and Mn.

3. The cathode plate according to claim 1, wherein
in the cathode active material, a mass percentage of the first active material is 40-96%, a mass percentage of the second active material is 2-30%, and a mass percentage of the third active material is 2-30%.

4. The cathode plate according to claim 1, wherein
a mass percentage content of the third active material in the cathode active material is w, a volume resistivity of powder of the cathode active material under a pressure of 20 MPa is R, and w and R satisfy 0.025≤1000×w/R≤500.

5. The cathode plate according to claim 1, wherein
the first active material and the second active material are in the form of particles, and the form of particles both selects one of monocrystalline particles, polycrystalline particles, or a mixture of monocrystalline and polycrystalline particles.

6. The cathode plate according to claim 1, wherein
the particle size of the first active material satisfies Dv10≥0.5 μm, and 1 μm≤Dv50≤7 μm.

7. The cathode plate according to claim 1, wherein
the particle size of the second active material satisfies Dv10≥1.0 μm, and 2 μm≤Dv50≤10 μm.

8. The cathode plate according to claim 1, wherein
the particle size of the third active material satisfies that Dv50 is in the range of 0.2 μm-10 μm.

9. The cathode plate according to claim 1, wherein
primary particles D_{A} of the third active material are in the range of 20-300 nm.

10. The cathode plate according to claim 1, wherein
the third active material is at least one of dope-modified LiFePO₄ or LiMn₁₋ₓ₄Feₓ₄PO₄; wherein when the third active material comprises LiMn₁₋ₓ₄Feₓ₄PO₄, 0<x4<1.

11. The cathode plate according to claim 1, wherein
the surface of the third active material has a carbon coating layer, and the mass percentage of the carbon coating layer in the third active material is 0.1%-5%.

12. The cathode plate according to claim 1, wherein
in the cathode film, the mass percentage content of the cathode active material is 90 wt %-99.5 wt %.

13. The cathode plate according to claim 1, wherein
the cathode film also comprises a conductive agent, a binder and a solvent, and the weight ratio of the cathode active material, the conductive agent and the binder is 95: (1-5): (1-5).

14. The cathode plate according to claim 1, wherein
the cathode plate has a compaction density of 3.1 g/cm³-3.8 g/cm³.

15. The cathode plate according to claim 1, wherein
the cathode plate has a volume resistivity of Rs≤50 kΩ·cm.

16. A preparation method for the cathode plate according to claims 1, wherein the method comprises:
uniformly mixing a cathode active material, a conductive agent and a binder, and dispersing same in a solvent to form a cathode active slurry; and
coating the cathode active slurry on at least one surface of a cathode current collector, performing drying and cold pressing, and then forming a cathode film on a surface of the cathode current collector.

17. A lithium ion battery, comprising the cathode plate according to claims 1.
